(19) United States
(12) Patent Application Publication
(10) Pub. No.: US 2009/0183379 A1
(43) Pub. Date: Jul. 23, 2009

(54) Self cleaning blade razor holder

(76) Inventor: Ryan Lawrence Johnson, Hawley, PA (US)

Correspondence Address: Ryan Johnson, 31 Old Indian Spring Rd., Andover, NJ, 07821-3919, US

(21) Appl. No.: 12/156,661

(22) Filed: Jun. 4, 2008

Related U.S. Application Data
(60) Provisional application No. 61/011,803, filed on Jan. 22, 2008.
(60) Provisional application No. 61/067,022, filed on Feb. 25, 2008.

(51) Int. Cl. B26B 21/40

(52) U.S. Cl. 30/538; 30/541

(57) ABSTRACT

A hanging or standing blade razor holder incorporating a razor head cleaning submersion cup, with a slotted hinged cover.

### CROSS REFERENCE TO RELATED APPLICATIONS

U.S. Provisional Patent Application No. 61/011,803 filed on Jan. 22, 2008 containing the invention titled, “Self cleaning blade razor stand” and U.S. Provisional Patent Application No. 61/067,022 filed on Feb. 25, 2008 containing the invention titled, “Self cleaning blade razor hanger” are consolidated in the present non-provisional patent application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention is a self cleaning blade razor holder that expedites and simplifies the cleaning and sterilization of a blade razor, and the preservation of the blades of said razor while conveniently storing said razor.

When a blade razor is rinsed in tap water after use, mineral deposits and bacteria remain on the razor blade(s). Minerals from the water form deposits on the razor blade(s) causing the blade surfaces or edges to become rough. Corrosion also contributes to the roughness of the blades. During subsequent uses, the rough blade(s) irritate the user's face causing razor burn or a rash where the skin has been scraped. Bacteria from the water, and from the user's face, also remain on the used razor blade(s) after rinsing. These bacteria infect the scrapes caused by the rough blade(s), further exacerbating the razor burn or rash.

### BRIEF SUMMARY OF THE INVENTION

Existing razor stands and hangers are limited because these stands and hangers do not incorporate a cleaning and sterilizing system. A separate shaving mug or lather bowl must be used with these stands and hangers in order to hold a cleaning agent. Existing shaving mugs and lather bowls are limited because: (a) these mugs and bowls do not incorporate an integrated razor stand or razor hanger, and (b) these mugs and bowls do not incorporate a cover or lid to: (1) keep dust and debris out, or (2) limit the evaporation of the cleaning agent. In contrast to existing art, the present invention simultaneously prevents mineral deposits from forming on the blade(s), prevents corrosion of the blade, kills bacteria and viruses on the blade(s), and conveniently stores the razor. When a lubricant cleanser such as but not limited to shaving oil is used with the present invention, any lubricating strips on the razor head are preserved. The present invention also incorporates a hinged cover, unlike existing art.

### BRIEF DESCRIPTION OF THE SEVERAL VIEWS OF THE DRAWING

The drawings are for illustrative purposes only and do not embody all possible variations of the entire invention.

FIG. 1 is a frontal/side/overhead view of the self cleaning blade razor hanger incorporating the hanging hook. FIG. 1 is labeled as follows:

A. Hanging hook.

B. Razor handle support cradle.

C. Hinged slotted cover.

D. Razor head submersion cup.

FIG. 2 is a frontal/side/overhead view of the self cleaning blade razor hanger incorporating the inverted cover. FIG. 2 is labeled as follows:

A. Hanging hook.

B. Razor handle support cradle.

C. Hinged slotted cover.

D. Razor head submersion cup.

FIG. 3 is a frontal/side/overhead view of the self cleaning blade razor hanger incorporating suction cups in lieu of any hanging hook or cord. FIG. 3 is labeled as follows:

A. Razor handle support cradle.

B. Suction cups.

C. Hinged slotted cover.

D. Razor head submersion cup.

FIG. 4 is a frontal/side/overhead view of the self cleaning blade razor hanger incorporating a hanging cord in lieu of any hook or suction cups. FIG. 4 is labeled as follows:

A. Hanging cord.

B. Razor handle support cradle.

C. Hinged slotted cover.

D. Razor head submersion cup.

FIG. 5 is a frontal/side/overhead view of the self cleaning blade razor hanger incorporating both a hanging cord and suction cups in lieu of a hook. FIG. 5 is labeled as follows:

A. Hanging cord.

B. Razor handle support cradle.

C. Suction cups.

D. Hinged slotted cover.

E. Razor head submersion cup.

FIG. 6 is a frontal/side/overhead view of the self cleaning blade razor stand. FIG. 6 is labeled as follows:

A. Razor handle support cradle.

B. Razor handle support post.

C. Hinged slotted cover.

D. Razor head submersion cup.

E. Weighted base.

FIG. 7 is a frontal/side/overhead view of the self cleaning blade razor hanger incorporating a full razor cover, and a locking suction cup in lieu of any hanging hook or cord. FIG. 7 is labeled as follows:

A. Hinge pin. (There are two of these pins: one pin through each side of the full razor cover and through each respective side of the razor head submersion cup).

B. Suction cup.

C. Razor handle support plate.

D. Suction cup with integral post.

E. Rigid conical washer.

F. Hinge pin. (This pin holds the suction cup post between the two suction cup hinge arms).

G. Suction cup post.

H. Suction cup hinge arm. (There are two of these arms: one on each side of the suction cup post).

I. Full razor cover.

J. Razor head submersion cup.

### DETAILED DESCRIPTION OF THE INVENTION

The present invention includes two main types of razor holders: a self cleaning blade razor hanger, and a self cleaning blade razor stand. The self cleaning blade razor hanger has a hook adapted to hang on a horizontal object including but not limited to a rod, shelf, basket, or plumbing item; a cup shaped container for the purpose of: (a) holding a cleaning and sanitizing agent, such as but not limited to: (1) rubbing alcohol, (2) barbershop/salon disinfectant, or (3) shaving oil; and (b) holding and submersing the entire razor head, including the blade(s), in said cleaning and sanitizing agent; a hinged lid or cover on top of said cup shaped container, having a notch or slot in said lid or cover to allow the razor handle to protrude up through said lid or cover; and a cradle affixed to said hook for the purpose of supporting the handle of said razor in an upright position.

The slot in the cover cuts partially past the center of said cover, beginning at the edge of said cover horizontally opposite the hanging hook and cradle. The hinge is located on the edge of the cover nearest the hook and cradle. Said hinge allows the razor to be placed in the hanger with the cover open and leaned against said cradle. Then said slot accepts the razor handle when the cover is closed over the razor head. Alternatively, the location of said slot and said hinge may be inverted so that said slot begins at the edge of the cover nearest the hook and cradle, and said hinge is located on the edge of the cover horizontally opposite the hook and cradle.

Another alternative razor hanger incorporates all the features above omitting said hanging hook and adapting suction cups to hold said razor hanger to a vertical surface including but not limited to walls or doors. The narrow tips of two conical suction cups are affixed to the vertical plate to which the cradle is attached, on the rear plate face opposite the cradle. This allows the self cleaning blade razor hanger to be temporarily attached to a vertical surface when the wide concave surface of said cups are pressed against said vertical surface. A cord may also be adapted to hang said razor hanger from a horizontal object including but not limited to a rod, shelf, basket, or plumbing item. Said cord may be in addition to said suction cups or in lieu of said suction cups.

The self cleaning blade razor stand incorporates a weighted base affixed to the bottom of the razor submersion cup in lieu of any hanging hook, suction cups, or cord. This allows the razor stand to sit upright on a horizontal surface such as, but not limited to, a counter top.

The self cleaning blade razor holder components may be cast, stamped, drawn, molded, blown, carved, machined, or otherwise manufactured from a variety of materials including but not limited to plastic, metal, glass, and/or wood.

What is claimed is:

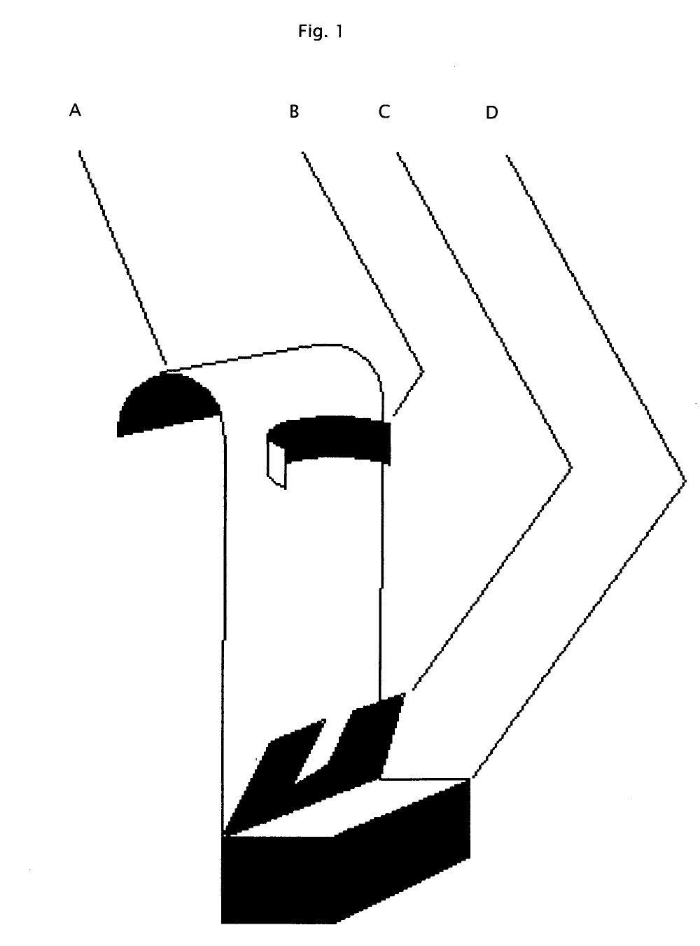

1. A self cleaning blade razor hanger having:
a hook adapted to hang on a horizontal object including but not limited to a rod, shelf, basket, or plumbing item;
a cup shaped container for the purpose of: (a) holding a cleaning and sanitizing agent, such as but not limited to rubbing alcohol, and (b) holding and submersing the entire razor head, including the blade(s), in said cleaning and sanitizing agent;
a hinged lid or cover on top of said cup shaped container, having a notch or slot in said lid or cover to allow the razor handle to protrude up through said lid or cover; and
a cradle affixed to said hook for the purpose of supporting the handle of said razor in an upright position.
See FIG. 1.

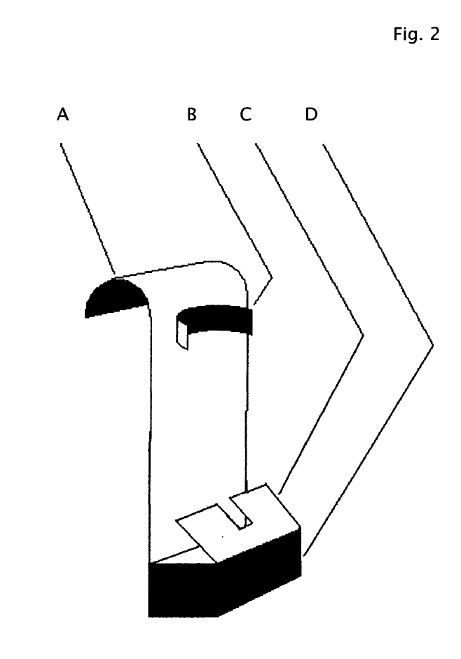

2. A self cleaning blade razor hanger incorporating all the features of Claim Number 1, except the orientation of said lid or cover is rotated 180 degrees horizontally so the hinge opposite the cradle and the slotted edge of the cover is near the cradle.
See FIG. 2.

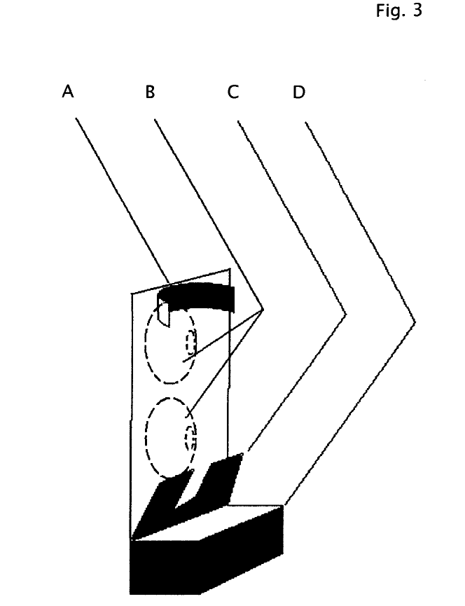

3. A self cleaning blade razor hanger incorporating all the features of Claim Number 1, except said hook is omitted and suction cups are adapted to hold said razor hanger to a vertical surface including but not limited to walls or doors.
See FIG. 3.

4. A self cleaning blade razor hanger incorporating all the features of Claim Number 2, except said hook is omitted and suction cups are adapted to hold said razor hanger to a vertical surface including but not limited to walls or doors.

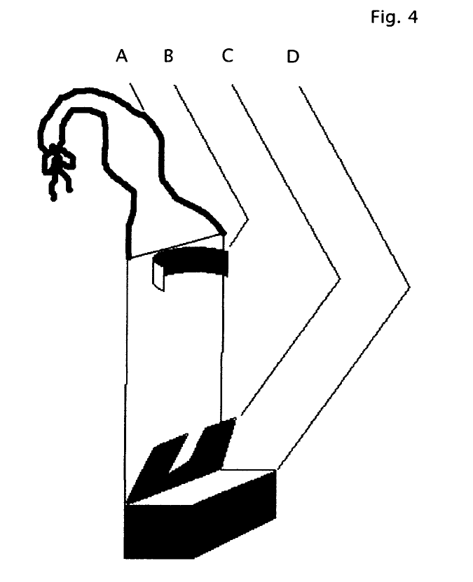

5. A self cleaning blade razor hanger incorporating all the features of Claim Number 1, except said hook is omitted and a cord is adapted to hang said razor hanger from a horizontal object including but not limited to a rod, shelf, basket, or plumbing item.
See FIG. 4.

6. A self cleaning blade razor hanger incorporating all the features of Claim Number 2, except said hook is omitted and a cord is adapted to hang said razor hanger from a horizontal object including but not limited to a rod, shelf, basket, or plumbing item.

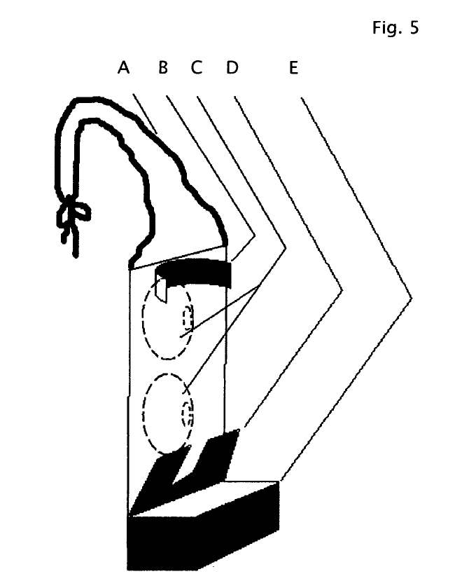

7. A self cleaning blade razor hanger incorporating all the features of Claim Number 1, and all the features of Claim Number 3 and Claim Number 4.
See FIG. 5.

8. A self cleaning blade razor hanger incorporating all the features of Claim Number 2, and all the features of Claim Number 3 and Claim Number 4.

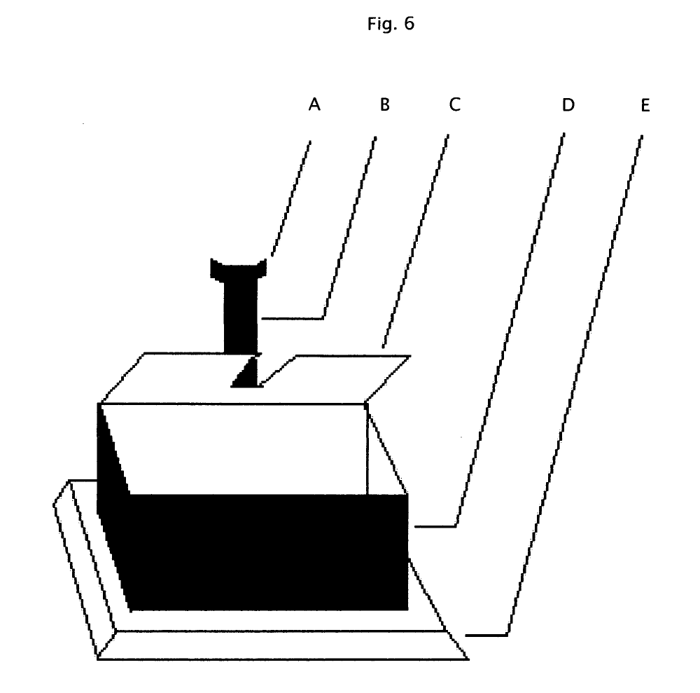

9. A self cleaning blade razor stand incorporating all the features of Claim Number 1, and a weighted base affixed to the bottom of the submersion cup in lieu of any hanging hook, suction cups, or cord.
See FIG. 6.

10. A self cleaning blade razor stand incorporating all the features of Claim Number 2, and a weighted base affixed to the bottom of the submersion cup in lieu of any hanging hook, suction cups, or cord.

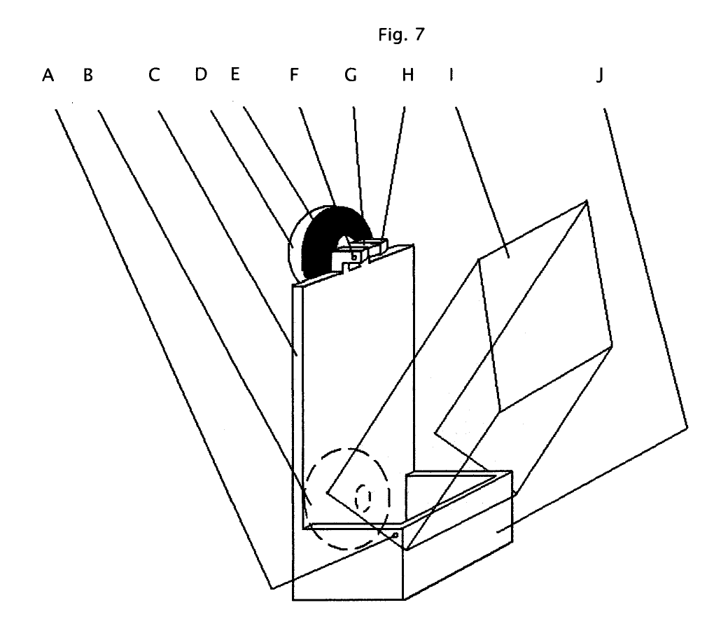

11. A self cleaning blade razor hanger having:
A locking suction cup consisting of: (a) a suction cup with an integral post, (b) a hole through said post, (c) a rigid conical washer, (d) two hinge arms—one on each side of the suction cup post, (e) a hole through said hinge arms, said holes offset away from said suction cup and said arms affixed to the top of the razor handle support plate, and (f) a pin through all three said holes holding said suction cup post between said hinge arms but allowing said suction cup post to pivot;
A suction cup affixed to the lower back face of the razor handle support plate to stabilize the razor hanger and aid the locking suction cup in hanging said razor hanger on a vertical surface including but not limited to walls or doors;
a cup shaped container for the purpose of: (a) holding a cleaning and sanitizing agent, such as but not limited to rubbing alcohol, and (b) holding and submersing the entire razor head, including the blade(s), in said cleaning and sanitizing agent;
a hinged cover on top of said cup shaped container, covering the entire razor and cup shaped container when closed.
See FIG. 7.

12. A self cleaning blade razor hanger incorporating all the features of Claim Number 11, but having two standard suction cups in lieu of any locking suction cup.

13. A self cleaning blade razor hanger incorporating all the features of Claim Number 12, and a cord is adapted to hang said razor hanger from a horizontal object including but not limited to a rod, shelf, basket, or plumbing item.

14. A self cleaning blade razor hanger incorporating all the features of Claim Number 11, and a cord is adapted to hang said razor hanger from a horizontal object including but not limited to a rod, shelf, basket, or plumbing item.

15. A self cleaning blade razor hanger incorporating all the features of Claim Number 11, except a hook is adapted to hang on a horizontal object including but not limited to a rod, shelf, basket, or plumbing item in lieu of any suction cups.
